(19) United States
(12) Patent Application Publication
(10) Pub. No.: US 2022/0194075 A1
(43) Pub. Date: Jun. 23, 2022

(54) CIRCUIT AND METHOD FOR DETECTING FAILING NOZZLES IN AN INKJET PRINT HEAD

(71) Applicant: Canon Production Printing Holding B.V., Venlo (NL)

(72) Inventor: Eduard T.H. DE GRIJS, Venlo (NL)

(73) Assignee: Canon Production Printing Holding B.V., Venlo (NL)

(21) Appl. No.: 17/549,338

(22) Filed: Dec. 13, 2021

(30) Foreign Application Priority Data
Dec. 21, 2020 (NL) 2027178

(51) Int. Cl. B41J 2/045; G06K 15/02

(52) U.S. Cl. CPC B41J 2/0451; B41J 2/0456; B41J 2/04581; G06K 15/1881; B41J 2/04558

(57) ABSTRACT

The invention relates to a method for detecting a failing ejection unit in an array of ejection units during printing of a digital image with liquid ink in a printer wherein a medium is transported relative to the array. The printed image is captured to density values on print positions of the printed image. The invented method comprises a step of adapting a halftone mask that is used in preparation of the digital image, such that from a variation in the image density around the line shaped defect the exact nozzle number associated with the failing ejection unit can be determined.

### CROSS-REFERENCE TO RELATED APPLICATIONS

This application claims priority to Dutch Patent Application No. NL2027178, filed on Dec. 21, 2020, the entirety of which is expressly incorporated herein by reference.

### BACKGROUND OF THE INVENTION

### 1. Field of the invention:

The present invention generally pertains to detecting ejection abnormalities in an inkjet print head, in particular a piezo-actuated inkjet print head.

### 2. Background of the invention:

During the execution of an ink jet print process, using a page wide array of ejection units, several faults can disturb the jetting of a drop from a nozzle, being the part of an ejection unit where a drop originates, leading to ejection abnormalities. For example, blocking of an ink nozzle due to the presence of a dirt particle is one of the most common causes of malfunction in ink jetting. In many printers, nozzle failures are detected by printing a test chart and optically checking the result. It is usually no problem to find an exact nozzle number of a failing nozzle, since only one of a plurality of nozzles has fired, and the number is inferred from a position of a missing dot. However, it is necessary to print this dedicated test chart.

It is also a known procedure to optically scan a printed image in order to infer the presence of failing nozzles from stripes occurring in a transport direction. However, the accurate nozzle number is often difficult to determine, due to the limited optical resolution of the scanner, the high density of ejection units and alignment differences between the print head arrays and the scanner.

As a consequence, it is desired to have a method for detecting failing nozzles in an array of ejection units during printing of an arbitrary image, such as a print job from a customer, wherein an accurate nozzle number of a failing nozzle is determined.

### SUMMARY OF THE INVENTION

In an aspect of the present invention, a method of detecting failing nozzles in an array of ejection units during the printing of an image onto a recording medium, the method comprising the steps according to claim 1 is provided. The recording medium and the one or more ejection units are arranged to be moved relative to one another in a transport direction perpendicular to a page width direction. In an embodiment, said ejection units are arranged to eject droplets of a liquid and comprise one or more of nozzles, one or more liquid ducts each connected to one of the one or more nozzles, and one or more electro-mechanical transducers each arranged to create an acoustic pressure wave in the liquid in one or more ducts. In an embodiment, the ejection unit is further arranged to sense a residual pressure wave in the liquid in each of the one or more ducts.

The method of the present invention comprises creating a halftone mask for the object of the print job that specifies the droplets to be ejected by each of the one or more nozzles onto the recording medium during the printing of the image, wherein the halftone mask is created such that a different variation is introduced in the page width direction depending upon which of the one or more nozzles in one or more ejection units is failing. In a further embodiment, a number of parameters that are used in the analysis of a residual pressure wave are determined with the aid of the determination of failing nozzles along the steps of the invented method.

In another step, the method of the present invention comprises actuating the electro-mechanical transducer to generate a pressure wave in the liquid in one of the one or more liquid ducts such that droplets are ejected by each of the one or more nozzles in one or more ejection units according to the halftone mask created in the step of creating a halftone mask.

In another step, the method of the present invention comprises scanning the recording medium to analyze the image printed onto the recording medium. Said scanning process is usually an optical scanning process. The optical resolution of the scanning process is limited allowing only a coarse determination of a failing nozzle number. The summing method provides an exact determination of this number. This is for example the case when the density of dots within a row amounts to 1200 dpi and the groups of dots comprise 5 columns and about 50 rows.

In another step, the method of the present invention comprises detecting failing nozzles amongst the one or more nozzles in one or more ejection units from the image resulting from the scanning step.

In an embodiment, the method of the present invention comprises that the halftone mask created for the object of the print job that specifies the droplets to be ejected by each of the one or more nozzles onto the recording medium is substituted by a standard halftone mask depending upon the content of the image to be printed onto the recording medium. This allows not using the created halftone mask but a standard one (as shown in FIG. 4A below) for dynamic situations such as the printing of text of certain particular content in photography, because the created halftone mask can have a detrimental effect in these situations. For this end, the droplet ejection device or the printing system of the present invention may contain a content detector that analyzes the content of the image to be printed onto the recording medium in order to determine whether using a standard halftone mask would be more beneficial.

In an embodiment, detecting failing nozzles amongst the one or more nozzles in one or more ejection units from the image resulting from the scanning step comprises several steps. One step comprises defining one or more groups in the transport direction and one or more groups in the page width direction. In another step, the amount of ejected droplets for each of the one or more groups in the transport direction is counted. This counting process takes place for those nozzles detected to be failing nozzles by analyzing the scanned image. In an embodiment, droplets are not directly counted, but certain areas are averaged (as observed below in FIG. 5B). Usually, said areas are significantly larger than the failing nozzle position, in de print with direction. Then, the method comprises summing the amount of droplets counted in the previous step for each group in the page width direction. Finally, failing nozzles amongst the one or more nozzles in one or more ejection units are inferred from the result of the summing step.

In an embodiment, the method of the present invention comprises that the halftone mask created for the object of the print job that specifies the droplets to be ejected by each of the one or more nozzles onto the recording medium is substituted by a standard halftone mask, and the method further comprises a post-processing step that alters the previous actuation (step b) such that droplets ejected by each of the one or more nozzles are displaced depending upon the group in the transport direction to which they belong. For this end, the droplet ejection device or the printing system of the present invention may also contain a content detector that analyzes the content of the image to be printed onto the recording medium in order to determine whether using a standard halftone mask together with a post-processing step would be more beneficial.

In an embodiment, the method of the present invention comprises sensing a residual pressure wave in the liquid in each of the one or more liquid ducts. Further, it comprises comparing the residual pressure wave sensed in the liquid in each of the one or more liquid ducts with the residual pressure wave of a correctly functioning unit by determining the difference of one or more parameters of the residual pressure wave sensed with the same one or more parameters of a correctly functioning unit such that failing nozzles are detected. Further, it also comprises using the result of the comparison between residual pressure waves for improving the detection of failing nozzles.

In an embodiment, the method of the present invention comprises that the halftone mask for the object of the print job that specifies the droplets to be ejected by each of the one or more nozzles has coverage between 5% and 100%. The lower the amount of correction, the more difficult it is detecting the correct nozzle failure number, but a lower amount of correction leads to less distortion in the print. So it is needed to reduce the amount of correction until the distortions in the prints are not visible any more. This depends on the print process situation (needed quality, print resolution, droplet sizes, etc.)

In an embodiment, the method of the present invention comprises that the halftone mask for the object of the print job that specifies the droplets to be ejected by each of the one or more nozzles has an amount of correction between 5% and 100%, wherein the amount of correction specifies the number of droplets ejected by the one or more of nozzles of the one or more ejection units that change their ejection position in comparison with a standard halftone mask.

The present invention also pertains to a droplet ejection device comprising a number of ejection units arranged to eject droplets of a liquid and each comprising a nozzle, a liquid duct connected to the nozzle, and an electro-mechanical transducer arranged to create an acoustic pressure wave in the liquid in the duct, wherein each of the ejection units is associated with a processor configured to perform the method according to any of the methods of the present invention.

Further, the present invention relates to a printing system comprising the droplet ejection device of the present invention as an ink jet print head and a control unit comprising a processor suitable for executing the method according to any of the methods of the present invention.

Also, the present invention relates to a software product comprising program code on a machine-readable non transitory medium, the program code, when loaded into a control unit of the printing system of the present invention, causes the control unit to execute any of the methods of the present invention.

### BRIEF DESCRIPTION OF THE DRAWINGS

The present invention will become more fully understood from the detailed description given below, and the accompanying drawings which are given by way of illustration only, and are thus not limitative of the present invention, and wherein:

FIG. 1 is a cross-sectional view of mechanical parts of a droplet ejection device according to the invention, together with an electronic circuit for controlling and monitoring the device.

FIG. 2A is a diagram of a printing system according to an embodiment of the invention.

FIG. 2B is a diagram of another printing system according to an embodiment of the invention.

FIG. 3 shows an example of a halftone mask according to the invention as well as an example of the process of inferring a nozzle failure from a printed medium.

FIG. 4A shows an example of a standard halftone mask.

FIG. 4B shows another example of a halftone mask according to the invention as well as an example of the process of inferring a nozzle failure from a printed medium.

FIG. 5A shows the effect of a nozzle failure in the printed result when using a standard halftone mask.

FIG. 5B shows a step of the process of inferring nozzle failures.

FIG. 5C shows another step of the process of inferring nozzle failures.

### DETAILED DESCRIPTION OF THE PREFERRED EMBODIMENTS

The present invention will now be described with reference to the accompanying drawings, wherein the same or similar elements are identified with the same reference numeral.

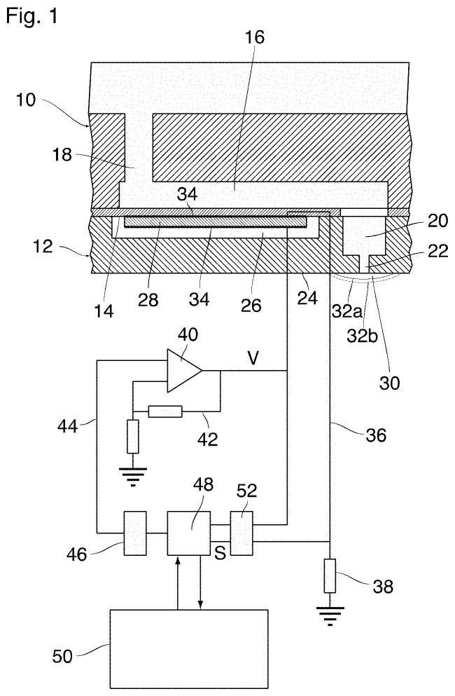

A single ejection unit of an ink jet print head is shown in FIG. 1. The print head constitutes an example of a droplet ejection device according to the invention. The device comprises a wafer 10 and a support member 12 that are bonded to opposite sides of a thin flexible membrane 14.

A recess that forms an ink duct 16 is formed in the face of the wafer 10 that engages the membrane 14, e.g. the bottom face in FIG. 1. The ink duct 16 has an essentially rectangular shape. An end portion on the left side in FIG. 1 is connected to an ink supply line 18 that passes through the wafer 10 in thickness direction of the wafer and serves for supplying liquid ink to the ink duct 16.

An opposite end of the ink duct 16, on the right side in FIG. 1, is connected, through an opening in the membrane 14, to a chamber 20 that is formed in the support member 12 and opens out into a nozzle 22 that is formed in a nozzle face 24 constituting the bottom face of the support member.

Adjacent to the membrane 14 and separated from the chamber 20, the support member 12 forms another cavity 26 accommodating a piezoelectric actuator 28 that is bonded to the membrane 14.

An ink supply system which has not been shown here keeps the pressure of the liquid ink in the ink duct 16 slightly below the atmospheric pressure, so as to prevent the ink from leaking out through the nozzle 22.

The nozzle face 24 is made of or coated with a material which is wetted by the ink, so that adhesion forces cause a pool 30 of ink to be formed on the nozzle face 24 around .the nozzle 22. The pool 30 is delimited on the outward (bottom) side by a meniscus 32a.

The piezoelectric transducer 28 has electrodes 34 that are connected to an electronic circuit that has been shown in the lower part of FIG. 1. In the example shown, one electrode of the transducer is grounded via a line 36 and a resistor 38. Another electrode of the transducer is connected to an output of an amplifier 40 that is feedback-controlled via a feedback network 42, so that a voltage V applied to the transducer will be proportional to a signal on an input line 44 of the amplifier. The signal on the input line 44 is generated by a D/A-converter 46 that receives a digital input from a local digital controller 48. The controller 48 is connected to a processor 50.

When an ink droplet is to be expelled from the nozzle 22, the processor 50 sends a command to the controller 48 which outputs a digital signal that causes the D/A-converter 46 and the amplifier 40 to apply an actuation pulse to the transducer 28. This voltage pulse causes the transducer to deform in a bending mode. More specifically, the transducer 28 is caused to flex downward, so that the membrane 14 which is bonded to the transducer 28 will also flex downward, thereby to increase the volume of the ink duct 16. As a consequence, additional ink will be sucked-in via the supply line 18. Then, when the voltage pulse falls off again, the membrane 14 will flex back into the original state, so that a positive acoustic pressure wave is generated in the liquid ink in the duct 16. This pressure wave propagates to the nozzle 22 and causes an ink droplet to be expelled. The pressure wave will then be reflected at the meniscus 32a and will oscillate in the cavity formed between the meniscus and the left end of the duct 16 in FIG. 1. The oscillation will be damped due to the viscosity of the ink. Further, the transducer 28 is energized with a quench pulse which has a polarity opposite to that of the actuation pulse and is timed such that the decaying oscillation will be suppressed further by destructive interference.

The electrodes 34 of the transducer 28 are also connected to an A/D converter 52 which measures a voltage drop across the transducer and also a voltage drop across the resistor 38 and thereby implicitly the current flowing through the transducer.

Corresponding digital signals S are forwarded to the controller 48 which can derive the impedance of the transducer 28 from these signals. The measured electric response (current, voltage, impedance, etc.) is signaled to the processor 50 where the electric response is processed further.

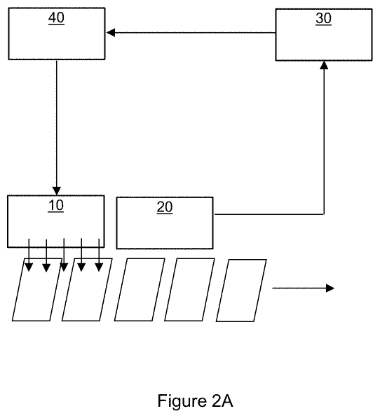

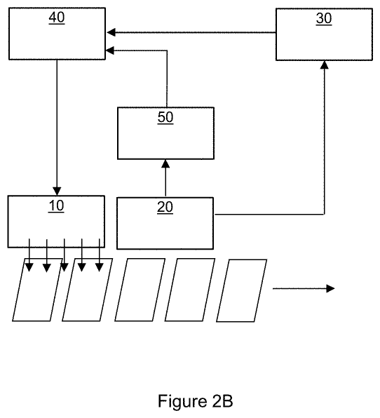

A diagram of a printing system is shown in FIG. 2A. It comprises one or more droplet ejection devices 10 which in turn comprise one or more ejection units which eject a liquid onto a recording medium. Further, the one or more ejection units and the recording medium are arranged to be moved relative to one another in a transport direction (x) perpendicular to the page width direction (y), as shown in FIG. 2A. After travelling under the one or more ejection units, said recording medium travels under a scanner 20. The ejection unit is arranged to eject droplets of a liquid and comprises one or more of nozzles, and one or more liquid ducts each connected to one of the one or more nozzles, and one or more electro-mechanical transducers each arranged to create an acoustic pressure wave in the liquid in one of the or more liquid ducts. The image resulting from scanner 20 is processed by a scan processing unit 30 which performs a process in which the image printed onto the recording medium is analyzed in order to detect failing nozzles amongst the one or more nozzles in one or more ejection units. Scan processing unit 30 delivers as result from its analysis of the scanned image the nozzle failures detected. In an embodiment, said scan processing unit 30 further provides a correction for the nozzles failures detected such that printing can continue without maintenance operations if compensation of the detected nozzles failures is possible. The result provided by the scan processing unit 30 is provided to image processing unit 40. Image processing unit 40 creates a halftone mask for the object of the print job that specifies the droplets to be ejected by each of the one or more nozzles onto the recording medium during printing. Said halftone mask is created such that a different variation is introduced in the page width direction when each of the one or more nozzles in one or more ejection units is failing. In an embodiment, image processing unit 40 alters the halftone mask in accordance with the nozzles failures detected in order to compensate.

A diagram of a printing system is shown in FIG. 2B. It comprises all of the elements of the printing system in FIG. 2A. In an embodiment, the system further comprises a residual pressure wave analysis unit 50. Said residual pressure wave analysis unit 50 performs a process in which a residual pressure wave in the liquid in each of the one or more liquid ducts is sensed, and subsequently said residual pressure wave sensed in the liquid in each of the one or more liquid ducts is compared with the residual pressure wave of a correctly functioning unit by determining the difference of one or more parameters of the residual pressure wave sensed with the same one or more parameters of a correctly functioning unit such that failing nozzles are detected. A person of skill in the art would readily understand that different processes may be used to decide which nozzles are failing from an analysis of a residual pressure wave, such as comparing one or more parameters of a residual pressure wave with those of a residual pressure wave of a correctly functioning nozzle, comparing one or more parameters of a residual pressure wave with its own parameters in previous executions, etc. Residual pressure wave analysis unit 50 determines which nozzles are failing, which can be subsequently used for improving the detection of failing nozzles. Said information is relayed to image processing unit 40 to be combined with the information received from scan processing unit 30.

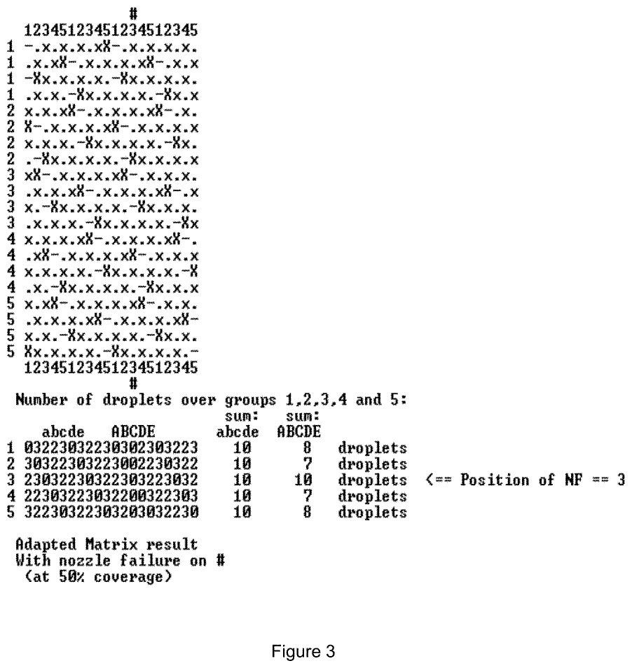

FIG. 3 represents an example of a halftone mask according to the present invention, with 50% coverage. The paper movement is in the vertical direction, also referred to as transport direction, which is perpendicular to a page width direction. The following symbols have been used:

“-” represents the position where a dot will be placed in a standard halftone mask, but it is empty in this mask.

“X” (capital x) represents a moved dot position (one pixel to the left or right side).

“#” represents the horizontal position where a nozzle failure is present.

In this process a plurality of groups are defined, which in the example of FIG. 3 amounts to five. Groups are defined in transport direction (each group is 4 pixel lines high in the example of FIG. 3. This example is just meant for explanation, in practice the number of pixels in a group is ten times as large). At the same time, in the page width direction the group changes every pixel column, comprising an equal number of columns, forming a kind of running average.

If the amount of droplets within each group vertically is counted, the result shows that there are 0 to 3 droplets within each group. Subsequently, the total number of droplets within a plurality of columns can be added (5 in the example of FIG. 3), a+b+c+d+e, the number of droplets counted remains the same (10 in the example of FIG. 3), except if there is a NF present. This allows ascertaining which of the nozzles is failing.

In the example of FIG. 3 a nozzle failure is present on column #. This can be inferred from the fact that the total of droplets around the nozzle failure within the plurality of columns A+B+C+D+E, we now can see that the group (=3) denoting the nozzle failure can be distinguished because there are more droplets counted in its neighborhood (10 droplets instead of 7 or 8 in the example of FIG. 3).

The method described is not always able to pinpoint exactly which nozzle is not ejecting correctly due to inaccuracies in the alignment between scanner and print head, but reaches an accuracy which depends upon the number of groups created (e.g. with 5 groups and accuracy of −2 of +2 nozzles is reached).

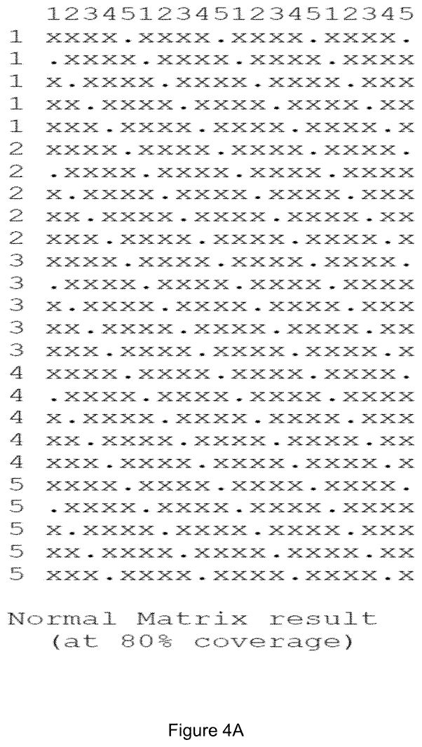

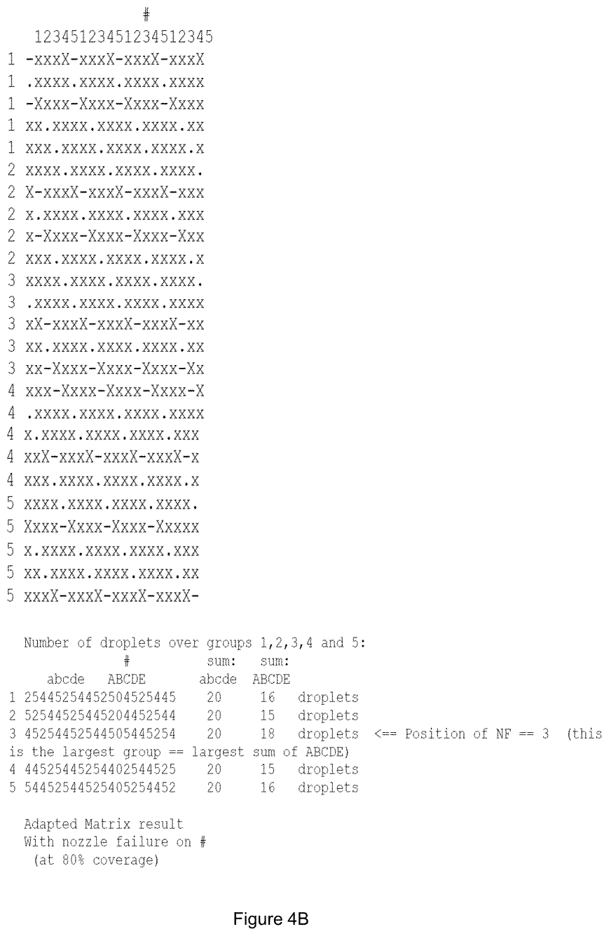

FIG. 4A shows an example of a standard halftone mask with 80% coverage. In turn, FIG. 4B shows a halftone mask according to the present invention with 80% coverage together with the process of inferring the failing nozzles from the result of ejecting liquid onto a recording medium using said halftone mask. FIG. 4B also shows the process of detecting failing nozzles amongst the one or more nozzles in one or more ejection units from the previously scanned image. As it can be observed in FIG. 4B one or more groups in the transport direction and one or more groups in the page width direction are defined. In a step, the amount of ejected droplets for each of the one or more groups in the transport direction are counted, as can be observed in the lower part of FIG. 4B. The result of the previous step is summed for each group in the page width direction. As it can be observed in FIG. 4B, failing nozzles amongst the one or more nozzles in one or more ejection units can be inferred from the result of the previous step.

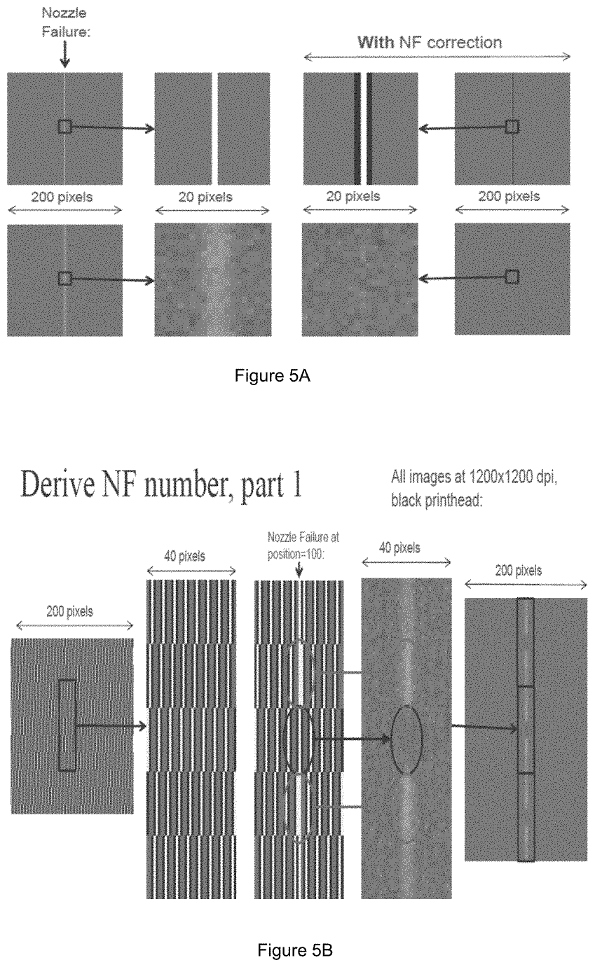

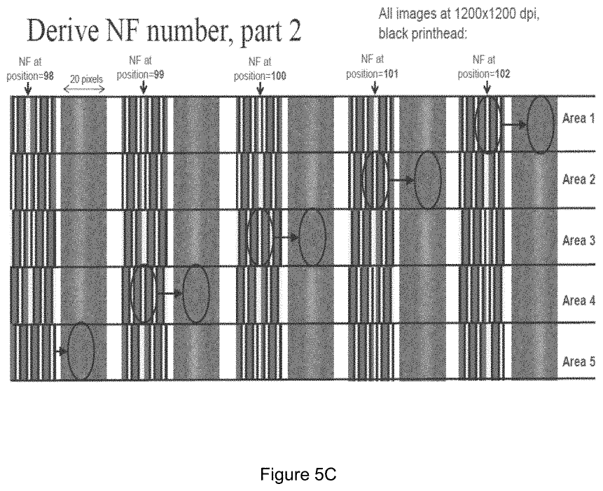

FIG. 5A shows the result of printing with a nozzle failure. In this example, a standard mask is used. It can be observed that a failing nozzle creates an empty line in the printed result, which can be reduced using known compensation methods.

FIG. 5B shows the result of a nozzle failure when a halftone mask of the present invention is used. It can be observed in FIG. 5B that a nozzle failure in a particular position creates a distinguishable pattern. Said distinguishable pattern is significantly different depending upon which of the nozzles is not ejecting correctly. FIG. 5C shows the distinguishable patterns created on the printed medium when there is a nozzle failure in different nozzles. Said distinguishable patterns can be analyzed in the printed media from a scanned image. This allows inferring with accuracy which nozzle is failing amongst all of the nozzles of one or more ejection units.

The invention being thus described, it will be obvious that the same may be varied in many ways. Such variations are not to be regarded as a departure from the scope of the invention, and all such modifications as would be obvious to one skilled in the art are intended to be included within the scope of the following claims.

1. A method for detecting a failing nozzle associated with an ejection unit in a page wide array of ejection units during the printing of an image by ejecting droplets of a liquid onto a recording medium that travels in a transport direction under the array of ejection units before travelling under an optical scanner, the droplets causing dots on the recording medium in rows parallel to the array and columns in the transport direction, the method comprising the steps of:
a) creating a halftone mask for preparing a digital image for the print process, wherein the halftone mask comprises a systematic variation for displacing a number of dots in a row direction:
b) printing an image with the halftone mask;
c) scanning the image with the optical scanner to determine a density value on each dot position associated with a row and a column;
d) defining groups of dot positions, corresponding to a number of columns and a number rows;
e) determining a sum of density values along the dot rows and dot columns within each group, and
f) determining a failing nozzle from a deviation in the sums of density values.

2. The method according to claim 1, wherein the halftone mask for printing the image depends on the content of the image.

3. The method according to claim 1, wherein a coarse determination of a failing nozzle is done by analyzing the density values for stripes in transport direction with reduced density and an exact determination is obtained from the sums in step e).

4. The method according to claim 1, wherein the density of dots within a row amounts to 1200 dpi and the groups of dots comprise 5 columns and about 50 rows.

5. The method according to claim 1, wherein the ejection units comprise a nozzle, a liquid duct, connected to the nozzle, and an electro-mechanical transducer arranged to create an acoustic pressure wave in the liquid in the duct, such that the functioning of the ejection unit is determined from a residual pressure wave analysis in combination with the steps a)-f).

6. The method according to claim 5, wherein a number of parameters that are used in the analysis of a residual pressure wave are determined with the aid of the determination of failing nozzles along the steps a)-f).

7. A droplet ejection device comprising:
a number of ejection units arranged to eject droplets of a liquid and each comprising a nozzle:
a liquid duct connected to the nozzle; and
an electro-mechanical transducer arranged to create an acoustic pressure wave in the liquid in the duct,
wherein the ejection units are associated with a processor configured to perform the method according to claim 5.

8. A print system comprising:
a page wide array of ejection units;
an optical scanner;
a recording medium transport system; and
a control unit comprising a processor configure to execute the method according to claim 1.

9. A print system comprising:
a page wide array of ejection units:
an optical scanner:
a recording medium transport system: and
a control unit comprising a processor configured to execute the method according to claim 2.

10. A print system comprising:
a page wide array of ejection units:
an optical scanner:
a recording medium transport system; and
a control unit comprising a processor configured to execute the method according to claim 3.

11. A print system comprising:
a page wide array of ejection units:
an optical scanner,
a recording medium transport system; and
a control unit comprising a processor configured to execute the method according to claim 4.

12. A print system comprising:
a page wide array of ejection units:
an optical scanner:
a recording medium transport system; and
a control unit comprising a processor configured to execute the method according to claim 5.

13. A software product comprising program code on a machine-readable non transitory medium, the program code, when loaded into a control unit of a printing system causes the control unit to execute the method according to claim 1.
